(19) United States
(12) Patent Application Publication
(10) Pub. No.: US 2024/0013146 A1
(43) Pub. Date: Jan. 11, 2024

(54) ASSET TRACKING SYSTEM

(71) Applicant: ORBINOX PTY LTD, Wendouree (AU)

(72) Inventors: Philip David Thomas, Brown HIll (AU); Bradley Thomas, Ballarat North (AU)

(73) Assignee: ORBINOX PTY LTD, Wendouree (AU)

(21) Appl. No.: 18/252,307

(22) PCT Filed: Oct. 12, 2021
(86) PCT No.: PCT/AU2021/051186

§ 371 Date: May 9, 2023

(30) Foreign Application Priority Data
Oct. 13, 2020 (AU) 2020903712

(51) Int. Cl. G06Q 10/087

(52) U.S. Cl. CPC G06Q 10/087

(57) ABSTRACT

A system for tracking an asset, comprising: a store configured to house the asset; a scanner configured to read asset identification data from a marker associated with the asset to identify the asset and thereby transmit asset location data and asset identification data to record the presence or absence of the asset within the store; a sensor configured to read user identification data to identify a user when the user is within the store; a controller configured to receive: the asset identification data and the asset location data in a first data packet from the scanner; and the user identification data in a second data packet from the sensor, and record the first data packet in conjunction with the second data packet in an asset record, wherein the controller is configured to repeatedly receive and write the first and second data packets to the asset record to assess over a predetermined time period the presence of the asset within the store or the absence of the asset in conjunction with the user, to thereby track the asset.

### FIELD OF THE INVENTION

The present invention relates to a system for tracking an asset, and to a method of tracking an asset using the system.

### BACKGROUND

Industrial worksites are frequented by many workers and sub-contractors. Often, these workers are issued, on-site, with equipment necessary for undertaking various tasks and jobs. In many cases, the issued equipment is specialised and expensive, and thus it is important for a company to be able to keep track of the equipment and its use across the worksite.

Against this backdrop, centralised inventory systems have been developed to monitor the dispensing of equipment to workers and sub-contractors. Conventional inventory systems typically involve the keeping of an equipment log, in which workers must manually sign-in and sign-out equipment taken from an equipment store. These systems; however, rely upon the workers to accurately identify and list the items being taken from and returned to the store. As an extra level of security, some inventory systems require that the dispensing of equipment be overseen by a supervisor. Understandably; however, supervision measures increase the costs associated with running the system and can be difficult for companies to justify.

To overcome some of these drawbacks, computerised inventory management systems can replace manual equipment logs with a computerised database. Such systems involve the use of a scan-in/scan-out process, with workers or supervisors using barcode scanners or the like when taking and returning inventory from the store. The computerised databases still rely on a degree of honesty and compliance from the workers, or supervision, to ensure that items are not taken from the store without being recorded. Also, the computerised databases are often maintained alongside a separate maintenance log, resulting in a doubling up of recording duties. Furthermore, whilst suited to tracking expensive pieces of equipment like power tools and meters, such systems are ill-suited to monitoring the use of consumable materials such as fixings, lubricants and the like, the over-use of which can negatively impact the company's financial bottom line.

Accordingly, it would be beneficial to provide an improved inventory management system to track the use of inventory by workers on a worksite. It would be desirable if such a system was suitable for use with both consumable and non-consumable inventory. It would be advantageous if an inventory management system could track the movement of inventory around a worksite.

The present invention was conceived with these shortcomings in mind.

### SUMMARY OF THE INVENTION

In a first aspect, the invention provides a system for tracking an asset, comprising: a store configured to house the asset; a scanner configured to read asset identification data from a marker associated with the asset to identify the asset and thereby transmit asset location data and asset identification data to record the presence or absence of the asset within the store; a sensor configured to read user identification data to identify a user when the user is within the store; a controller configured to receive: the asset identification data and asset location data in a first data packet from the scanner; and the user identification data in a second data packet from the sensor, and record the first data packet in conjunction with the second data packed in an asset record, wherein the controller is configured to repeatedly receive and write the first and second data packets to the asset record to assess over a predetermined time period the presence or absence of the asset within the store in conjunction with the user, to thereby track the asset.

An advantage provided by the asset tracking system is that the presence or absence of the asset within the store is associated with the identity of the user who last removed or returned the asset. As a result of this, the need for keeping manual equipment logs is reduced. Furthermore, the asset record provides an up-to-date record of the presence of the asset within the store, which therefore reduces the need for distinct asset stocktakes and audits.

The store may be transportable. The store may be a shipping container. As the store can be transported to the worksite already stocked with the asset, users have ready access to the asset without the need to travel to a separate shop or await delivery of the asset to the worksite.

In some embodiments, the sensor may comprise a camera. Alternatively or additionally, the sensor may comprise a barcode reader. By utilising the camera and/or the barcode reader, the identity of the user within the store can be identified automatically. This eliminates the need for the store to be manned by a storeman. Alternatively, the sensor may be a person. The person may visually identify the user and record the user's attendance within the store.

The asset may be a non-consumable asset. The non-consumable asset may be one of: a power-tool; a tool; a meter; a pair of gloves, a pair of goggles, a hard hat, a safety vest, a communication device, and a safety vest. The asset record may include safety data comprising at least one of scheduled testing information, maintenance information and life duration information related to the asset. The marker may be a transmitter. The marker may be a RFID tag. Alternatively, the marker may be a barcode. The marker may be attached directly to the non-consumable asset. The marker may be attached to a location within or upon which the asset is stored inside the store. The system may further comprise a secondary scanner for reading the marker and assessing movement of the asset from and to the location.

The asset may be a consumable asset. The consumable asset may be one of a plurality of fasteners, a plurality of nails, a plurality of screws, a quantity of fuel and a quantity of lubricant. The marker may be attached to a container within which the consumable asset is stored. The container may comprise an interrogation device for determining the quantity of the consumable asset stored therein. The interrogation device may be a weigh scale. The system may further comprise a movement detector for detecting movement of the asset from and to the container. The asset location data may relate to the quantity of the consumable asset stored within the container. The asset identification data may comprise the quantity of the consumable asset stored within the individual unit. The individual unit may be a packet comprising a discrete quantity of the consumable asset.

In some embodiments asset may be one of a plurality of assets stored in the store, each of the plurality of assets having a marker. The marker may be unique to the or each asset. Each asset record may be associated with the unique marker. The system may further comprise an asset registry, the asset registry comprising each of the asset records. The asset record may be linked to safety data for the asset, to record on the asset record at least one of: scheduled testing dates; maintenance information; and working life information.

The system may further comprise a user interface from which the user selects the asset from the asset registry. The store may comprise a guide configured to direct the user to the asset within the store. By using the guidance device, the user can easily locate the asset within the store.

In some embodiments, the system may further comprise a transceiver to detect the location of the asset outside of the store. The transceiver may be configured to send external location data to the controller. By incorporating the transceiver, the system can track use of the asset across the worksite.

In a second aspect, the invention provides a network comprising a central controller and an asset tracking system; the asset tracking system located within a worksite and comprising a store configured to house at least one asset and a controller within which an asset record associated with each of the assets is stored, each asset record comprising asset identification data and asset location data related to the respective asset; the central controller being located outside of the worksite; wherein the central controller is in communication with the controller of the asset tracking system, to access each of the asset records from outside of the worksite.

An advantage provided by the network is that asset location data from the asset records can be accessed from outside of the worksite. As such, it is possible to determine which assets are present or absent within the store without the need to visit the worksite itself.

The asset may be a consumable asset. The consumable asset may be one of a plurality of fasteners, a plurality of nails, a plurality of screws, a quantity of fuel and a quantity of lubricant. The asset may be a non-consumable asset. The non-consumable asset may be one of: a power-tool; a tool; a meter; a pair of gloves, a pair of goggles, a hard hat, a safety vest, a communication device, and a safety vest.

In some embodiments, the central controller may be in communication with the controller of the worksite via an external internet connection. The controller of the worksite may send the asset location data to the central controller at predetermined time intervals. The asset tracking system may be one of a plurality of asset tracking systems within the network, wherein the central controller reads asset location data from each of the controllers of each of the asset tracking systems

In some embodiments, the central controller may remotely monitor a quantity of the at least one asset present within the store. Remote monitoring of the quantity of the asset present within the store is advantageous, because a supplier can replenish the store so as to maintain levels of the asset, without the need for discrete asset audits or inventory orders.

The central controller may compare the quantity of the asset present within the store with a predetermined threshold. The central controller may provide an alert to a supplier if the quantity of the asset within the store is less than the predetermined threshold. The central controller may calculate an expected quantity of the asset required to complete a scheduled scope of works, and compare the quantity of the asset present within the store with the expected quantity. The calculation of the expected quantity of the asset required may be based on accumulated job data within the asset record. The central controller may provide an alert to a supplier if the quantity of the asset within the store is less than the expected quantity. The alert may provide an automatic trigger that results in a delivery of the asset from the supplier to the store.

In a third aspect, the invention provides a method for tracking an asset, the method comprising the following steps: (a) reading asset identification data from a marker associated with the asset with a scanner to identify a presence or absence of the asset within a store, and transmitting asset identification data and asset location data to a controller in a first data packet; (b) reading user identification data with a sensor to identify a user moving the asset into or out of the store, and transmitting the user identification data in a second data packet to the controller; (c) comparing the first data packet received from the scanner with a corresponding asset record stored within the controller to assess a change in the presence or absence of the asset within the store; and (d) writing the first data packet and second data packet to the asset record with the controller if the asset location data within the first data packet differs from the location data previously stored in the asset record, to thereby track the asset.

An advantage provided by this tracking method is an increased accountability bestowed upon the user for the use and return of the asset to the store. This is because the user identification data is written to the asset record. Accordingly, the method not only tracks the location of the asset with respect to the store, but also tracks the identity of the user who is using the asset.

In some embodiments, the steps (a) and (b) of the method may be undertaken by a person. The reading of the asset identification data from the marker by the person may be via a hand-held scanner. The reading of the user identification data of the user by the person may be via a scanning of an identification tag of the user. Step (a) may comprise reading asset identification data from an RFID tag associated with the asset. Alternatively, or additionally, step (a) may comprise reading asset identification data from a barcode associated with the asset. Alternatively, or additionally, step (a) may comprise reading asset identification data from the marker, the marker being attached to a location within the or upon which the asset, being a consumable asset, is stored inside the store. Step (b) may comprise identifying the user with a camera. The reading of identification data in step (a) may be automatically performed by the scanner at predetermined time intervals. Alternatively, the reading of identification data in step (a) may occur as the user moves into or out of the store. Step (a) may occur after step (b), with the scanner performing a scan of the store after receiving the second data packet. The method as described herein may be used to track a plurality of assets stored within the store.

### BRIEF DESCRIPTION OF THE DRAWINGS

Embodiments of the invention are illustrated by way of example, and not by way of limitation, with reference to the accompanying drawings, of which:

FIG. 1 is a schematic illustration of an asset tracking system for tracking movement of an asset into and out of a store;

FIG. 2 is a schematic illustration of an embodiment of the asset tracking system of FIG. 1, in which the store is a shipping container and the asset tracking system is an automated asset tracking system;

FIG. 3 is a schematic illustration of an embodiment of the asset tracking system of FIG. 1, in which the store is a shipping container and the asset tracking system is a manned asset tracking system;

FIG. 4 is a schematic illustration of the shipping container of FIG. 2 or FIG. 3, illustrating consumable and non-consumable assets stored in designated locations therein;

FIG. 5 is a schematic illustration of an embodiment of the asset tracking system of FIG. 2, deployed to a worksite;

FIG. 6 is a schematic illustration of an asset supply network incorporating two asset tracking systems deployed to two respective worksites interconnected with a central controller; and

FIG. 7 is a flowchart illustrating a method of tracking an asset with the asset tracking system.

Embodiments will now be described more fully hereinafter with reference to the accompanying drawings, in which various embodiments, although not the only possible embodiments, of the invention are shown.

### DETAILED DESCRIPTION

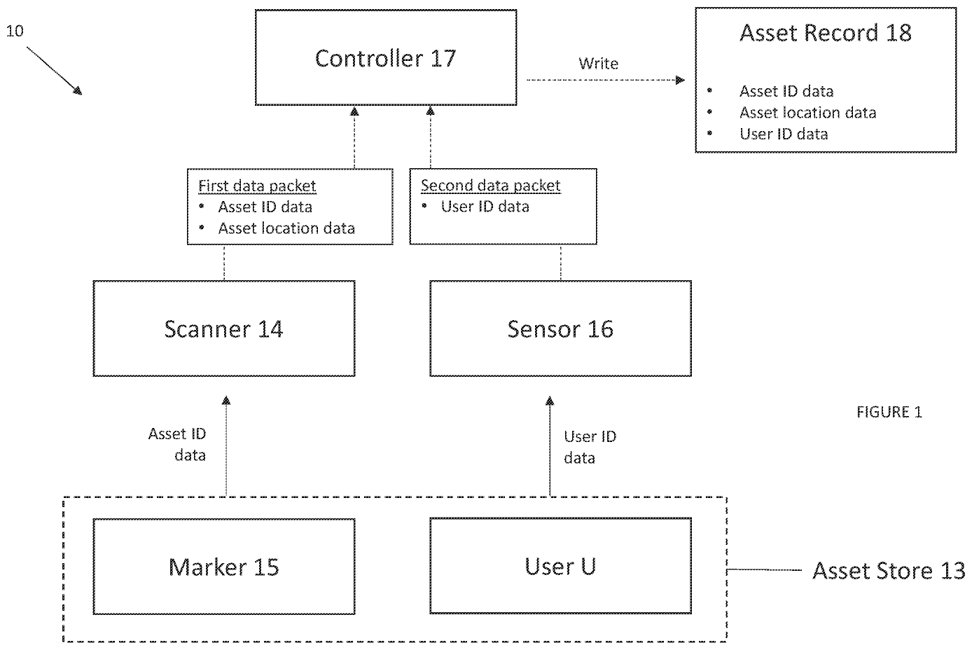

The invention as illustrated in FIGS. 1 to 7 broadly relates to an asset tracking system 10 for tracking an asset 11 within a worksite 12. Specifically, the system 10 tracks movements of the asset 11 into and out of an asset store 13, located within or adjacent to the worksite 12.

FIG. 1 provides a schematic illustration of the asset tracking system 10. The system 10 comprises a scanner 14 and a sensor 16. The scanner 14 reads asset identification data from a marker 15. The marker 15 comprises asset identification data that uniquely associates the marker 15 with the asset 11. The scanner 14 sends the asset identification data and asset location data in a first data packet to a controller 17. Asset location data identifies the location of the asset 11 relative to the asset store 13.

The sensor 16 reads user identification data from a user U, who enters the store 13 to move the asset 11 into or out of the store 13. The sensor 16 sends the user identification data in a second data packet to the controller 17. The controller 17 is configured to write the first and second data packets to an asset record 18.

The asset record 18 is uniquely associated with the asset 11, via the asset identification data. Accordingly, the asset record 18 comprises the location data which indicates the presence or absence of the asset 11 within the store 13, and the identification data to identify the asset 11, and the user U, to record in the asset record 18 which user is responsible for the movement of the asset 11 into or out of the store 13.

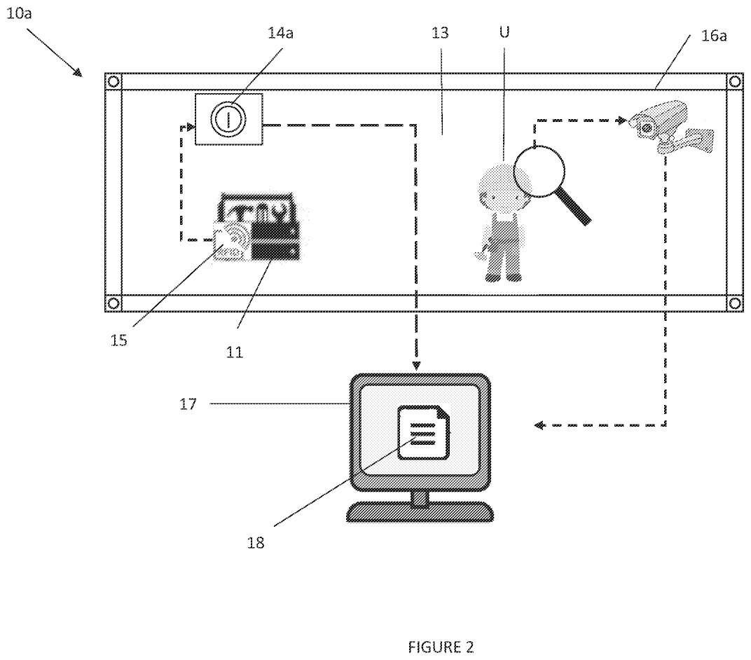

FIG. 2 illustrates an embodiment of the asset tracking system 10. In this embodiment, the asset tracking system is an automated asset tracking system 10a. The store is shown as a shipping container 13. In other embodiments, the store can be a storeroom within the worksite 12 or a lockable cabinet. The user U is shown within range of the sensor 16, illustrated as a camera 16a within the store 13, when collecting or returning the asset 11.

The camera 16a uses facial recognition to determine the identity of the user U within store 13. The camera 16a is located so as to determine the identity of the user U collecting or returning the asset 11 from the store. Accordingly, whilst illustrated as being located within the store 13, the camera 16a can also be located outside the store 13. Once the camera 16a has identified the user U, the camera sends the second data packet, comprising the user identification data, to the controller 17. In alternate embodiments, the sensor 16 can be a barcode reader. The barcode reader is configured to determine the identity of the user U by reading a label or barcode of an ID card unique to each user U. Each user U with access to the store 13 is provided with a unique ID card.

The scanner 14 can be an RFID scanner 14a for use in conjunction with the marker as an RFID tag 15 associated with the asset 11. The RFID tag 15 can be directly attached to the tool, embedded within a part of the tool, or associated with a toolbox in which the tool is housed within the store 13.

An advantage of the RFID tag 15 is that the RFID scanner 14a does not require line of site with the RFID tag 15 of the asset 11. This is because the RFID tag 15 transmits the asset identification data to the scanner 14 via a radio message. The RFID scanner 14a decodes the radio message to read asset identification data. It is also contemplated that the marker can be a barcode 15 that is readable by the RFID scanner 14a. The RFID scanner has an operative range extending across the store 13. Whilst shown in FIG. 2 as being located within the store 13, the RFID scanner 14a can alternatively be located outside of the store 13. Depending on the size of the store 13, more than one RFID scanner 14a can be used. In other embodiments (not shown) it is contemplated that other forms of radio based antennas and scanners 14 and markers 15 can be used. Non limiting examples include Bluetooth scanners and beacons, and GSM and LTE scanners and tracking tags.

Whilst discussed herein as separate components, the scanner 14 and sensor 16 can be integrated into a single device for ease of use.

The controller 17 can be located inside or outside of the store 13 depending on access requirements. The controller 17 is a computer or other electronic processor having a memory. The controller 17 is in local communication with both the camera 16a and the RFID scanner 14a to relay data therebetween via data packets. By local communication, it is understood that the connection between the controller 17 and the camera 16a and RFID scanner 14a is not dependent on an external internet supply. As such, the communication therebetween is robust and reliable.

The communication between the controller 17 and RFID scanner 14a can be a constant, or an intermittent communication repeated at discrete intervals. In one arrangement, the controller 17 communicates with the scanner 14 only when the user U leaves the store 13. In this arrangement, the controller 17 receives the second data packet from the camera 16a as the user U leaves the store 13. The controller 17 then triggers the RFID scanner 14a to perform a scan of the store 13. If the asset 11 is within the store 13, the RFID scanner 14a will receive the radio message from the RFID tag 15. After receiving the radio message, the RFID scanner 14a determines the presence of the asset 11 within the store 13. The RFID scanner 14a then sends the asset identification data and asset location data indicating that the asset 11 is present within the store 13 in the first data packet to the controller 17.

If the asset 11 is not within the store 13, the RFID scanner 14a will not receive the radio message from the RFID tag 15. When the RFID scanner 14a detects no radio message from the RFID tag 15 this indicates the absence of the asset 11 from the store 13. The RFID scanner 14a will then send the first data packet to the controller 17, wherein the asset location data will indicate the absence of the asset 11 and the asset record 18 will be updated to indicate the asset 11 has been removed from the store 13.

Alternatively, the trigger from the controller 17 to the RFID scanner 14a can be configured as a time trigger, sent over pre-determined time intervals. Where the time interval is short, for example one second or less, the RFID scanner 14a effectively performs continuous scans of the store 13, sending the location data from the most recently completed scan in the first data packet to the controller 17. In this time trigger configuration, the RFID scanner 14a provides a near real-time monitoring of the store 13.

In an alternative configuration, in particular for high-value assets 11, the RFID tag can be an active RFID tag. A benefit of an active RFID tag is that the RFID tag 15 constantly pushes radio messages containing asset identification data to the scanner 14. In this manner the location of high-value assets 11 is tracked within the store 13 in real-time.

On receiving new data, the controller 17 compares the first data packet received from the RFID scanner 14a with the asset record 18 previously stored within the controller 17. If the asset location data within the first data packet from the RFID scanner 14a differs from the asset location data within the asset record 18, the controller 17 writes the first data packet to the asset record 18. As such, the automated asset tracking system 10a tracks movement of the asset 11 into and out of the store 13, with the asset location data within the asset record 18 indicating the last known location of the asset 11 (i.e. whether the asset 11 is present or absent from the store 13). The controller 17 also writes the second data packet to the asset record 18 corresponding to the asset 11. Accordingly, the asset record 18 also provides a record of the identity of the user U who last collected or returned the asset 11 from the store 13. Movement of the asset 11 into and out of the store 13 is thus linked, or associated with the user U.

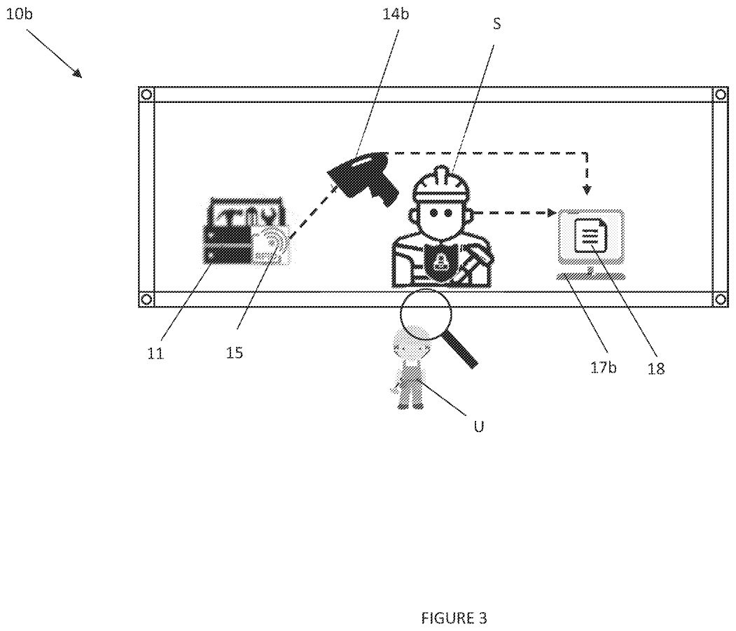

FIG. 3 illustrates an alternative embodiment of the asset tracking system 10. In this embodiment, the asset tracking system is a manned asset tracking system 10b. The manned asset tracking system 10b is similar to the automated asset tracking system 10a described above in relation to FIG. 2, with similar reference numerals indicating features having analogous functions.

The store is illustrated in this embodiment as shipping container 13. It is understood that the store can also be a lockable cabinet or a storeroom within the worksite 12. A supervisor S is located inside the store 13, having access to the controller 17. The supervisor S is a person or store attendant who physically overseas the removal and return of the assets 11 from the store 13. The controller is a computer 17b, located within the store 13. The user U is shown approaching the store 13, to collect or return the asset 11.

In this embodiment, the sensor 16 is the supervisor S. The supervisor S recognises the user U who is collecting or returning the asset 11 to the store 13 or identifies the user U from an ID badge or card. Once the supervisor S has identified the user U, the supervisor S enters the user identification data into the computer 17b manually. Alternatively, the supervisor S may use a barcode reader or similar to scan an ID card unique to the user U. The supervisor S in the manned asset tracking system 10b performs the function of the camera 16a as described in relation to the automated asset tracking system 10a of FIG. 2.

The scanner is a hand-held RFID scanner 14b, operated by the supervisor S. The marker is a RFID tag 15 attached to or uniquely associated with the asset 11. In some embodiments the marker can be a barcode 15 that is readable by the RFID scanner 14a.

The hand-held RFID scanner 14b has two operating modes. In a first “check-out” operating mode, the hand-held RFID scanner 14b is used by the supervisor S to issue the asset 11 to the user U. The hand-held RFID scanner 14b reads the asset identification data from the RFID tag 15. The asset identification data is then sent with the asset location data to the computer 17b, via the first data packet, indicating that the asset 11 is now absent from the store 13.

A second “check-in” operating mode is used by the supervisor S when the user U is returning the asset 11 to the store 13. The hand-held RFID scanner 14b reads the asset identification data from the RFID tag 15. The asset identification data is then sent with the asset location data to the computer 17 via the first data packet, indicating that the asset 11 is now present within the store 13. Accordingly, the operating mode of the hand-held RFID scanner 14b determines the asset location data that is sent in the first data packet.

It is contemplated that that the supervisor S can adjust the hand-held RFID scanner 14b between either of the first or second operating modes (check-in or check-out) by scanning a barcode or similar prior to scanning the RFID tag 15. Alternatively, there may be two hand-held RFID scanners 14, one for each operating mode. Accordingly, the mobile RFID scanner 14b when used by the supervisor S performs an analogous function to the RFID scanner 14a, as described in relation to the automated asset tracking system 10a of FIG. 2.

The mobile scanner 14b can also be configured to perform a “find function”. The find function is used by the supervisor S to find the asset 11 within the store 13. The mobile scanner 14b uses proximity detection to find the asset 11 within the store 13, the proximity detection being related to the strength of the signal received from the RFID tag 15. Once the computer 17b has received both the first data packet from the hand-held RFID scanner 14b and the supervisor S has entered the second data packet, the computer 17b then compares the first data packets with the asset record 18 corresponding to the asset 11. If the asset location data within first data packet from the RFID scanner 14a differs from the asset location data within the asset record 18, the controller 17 writes the first data packet and to the asset record 18. As such, the manned asset tracking system 10b tracks movement of the asset 11 into and out of the store 13, the asset location data within the asset record 18 then indicates the last known location of the asset 11 (i.e. whether the asset 11 is present or absent from the store 13). The computer 17b also writes the second data packet to the asset record 18 corresponding to the asset 11. Accordingly, the asset record 18 also provides a record of the identity of the user U who last collected or returned the asset 11 from the store 13.

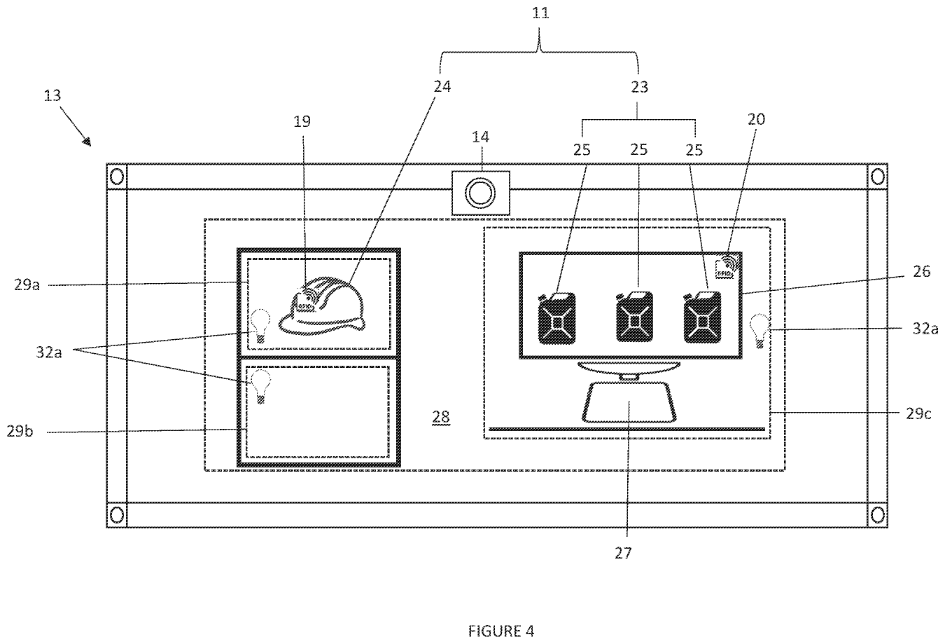

The store 13 will now be described in more detail, in reference to FIG. 4. Whilst heretofore described as a single asset 11, it is understood that the asset 11 can be one of a plurality of different assets 11 located within the store 13. Each of the assets 11 within the store 13 have a unique marker associated therewith. The markers can be asset markers 15 or a container marker 20. Each of the assets 11 is allocated its own unique asset record 18.

The plurality of assets 11 comprises consumable assets 23 and non-consumable assets 24. Consumable assets 23 are assets 11 that are dispensed from the store 13 but not returned. Examples of consumable assets 23 include fasteners, nails, screw, lubricants and fuels etc. Consumable assets 23 are dispensed as individual units 25, with a sum of individual units 25 making up a total quantity of the respective consumable asset 23 stored within the store 13.

Non-consumable assets 24 are assets 11 that are dispensed from the store 13 and returned after use. Examples of non-consumable assets 24 include power tools, tools, meters, googles, boots, safety vests, hard hats, personal protective equipment etc.

The store 13 shown in FIG. 4 includes a first non-consumable asset 24 in the form of a hard-hat, and a first consumable-asset 23 in the form of fuel, stored as three individual cans 25 within a container 26.

An interior 28 of the store 13 comprises designated locations 29 for storing assets 11. Designated locations 29 include shelves, aisles, racks and the like within the store 13.

Each designated location 29 is labelled, such that it can be located and identified by the user U. In the embodiment illustrated in FIG. 4, three designated locations 29 are shown 29a-29c. A storage rack comprises first and second designated locations 29a and 29b. The hard hat 24 is situated within first designated location 29a, whilst the second designated location 29b is empty and available. The third designated location 29c is represented within FIG. 4 as a free-standing shelf. The container 26, accommodating the three cans 25 of fuel 23, is disposed within designated location 29c.

When the user U returns a non-consumable asset 24 to the store 13, the controller 17 allocates a new storage location 29 from the available storage locations 29. As such, the storage location 29 for each non-consumable asset 24 can be flexible. In the embodiment shown in FIG. 4, were the user U to return an additional non-consumable asset 24 to the store 13, it would be allocated storage location 29b, being the only available storage location 29. If more than one storage location 29 is unoccupied within the store 13, the allocation of storage location 29 is chosen by the controller 17 to reduce an amount of time spent by the user within the store 13.

When collecting or returning one of the assets 11 from the store 13, a guidance system 32 within the store 13 guides the user U towards the storage location(s) 29 of the designated asset(s) 11. Because of the guidance system 32, the user requires no knowledge of the layout of the store 13 to find the selected asset(s) 11. In FIG. 4, the guidance system 32 comprises a plurality of indicator lights 32a.

It is contemplated that the scanner 14 can determine the designated storage location 29 of a respective asset 11 within the store 13 through triangulation or similar means related to the strength of signal received from the marker 15. Accordingly, the user U may return the additional non-consumable asset 24 to any available designated storage location 29 within the store 13. Upon the user leaving the store 13, the controller 17 updates the corresponding asset record 18, allocating the new storage location 29 to the additional non-consumable asset 24.

Consumable assets 23 are stored in the store 13 within containers 26. Each container 26 is located within one of the storage locations 29. Each container 26 includes or is seated upon an interrogation device 27. Interrogation devices 27 are used to determine a quantity of the consumable asset 23 currently contained within the respective containers 26.

The interrogation device 27 is in communication with the container marker 20. The container marker 20 can be attached to the container 20 and/or integrated within the interrogation device 27. The container marker 20 is a transmitter which transmits asset location data to the scanner 14. For consumable assets 23, asset location data relates to the quantity of individual units 25 of the respective consumable asset 23 currently present within the container 20. Whilst not shown in the illustrated embodiment, it is contemplated that the system 10 can comprise a movement detector. The movement detector determines when the user U removes individual unit(s) 25 from the container 26. Accordingly, the movement detector triggers the reading of the container marker 20 by the scanner 14.

The interrogation device is shown in FIG. 4 as a weigh scale 27. The container 26 is seated upon the weigh scale 27. The weigh scale 27 can be configured to determine the number of cans 25 within the container 26 by comparing a weight of the container 26 to a known weight of each individual can 25. The weigh scale 27 can also be configured to determine the amount of fuel within the can 25 to assess usage of fuel from the can 25 when returned to the store. The container marker 20 transmits asset identification data (indicating that the container 20 contains fuel 23) and location data (indicating that there are three cans presently located within the container 20) to the scanner 14.

Each non-consumable asset 24 has an asset marker 15 and a corresponding asset record 18. The asset marker 15 can be externally attached to each non-consumable asset 24 as a label or integrally integrated as a bespoke transmitting component. The asset marker 15 transmits asset identification data to the scanner 14. Whilst not shown in the illustrated embodiments, it is contemplated that each non-consumable asset 24 can be stored within a receptacle—such as a box—located within one of the storage locations 29. In such an embodiment, the system 10 can further comprise a secondary scanner. The secondary scanner reads the asset marker 15 as the non-consumable asset 24 is removed from the location 29 where the non-consumable asset 24 is stored. Accordingly, the secondary scanner then triggers the scanner 14 to transmit the first data packet to the controller 17

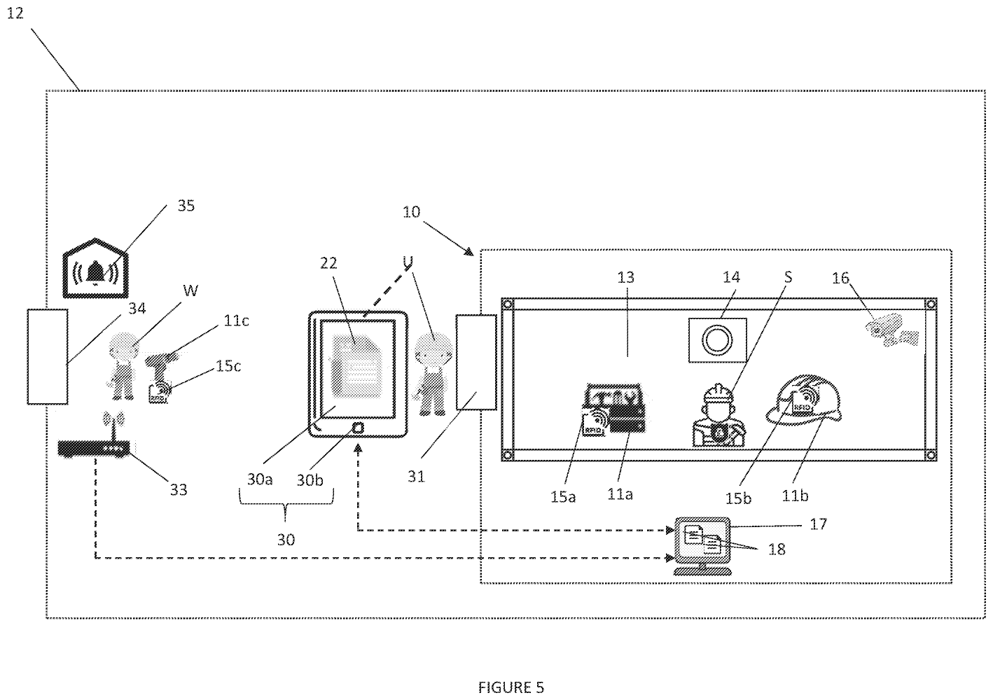

Referring now to FIG. 5, the asset tracking system 10 is shown deployed on the worksite 12. In this embodiment, the store 13 is a shipping container or cabin located within the worksite 12. In a smaller form, the store 13 can be a tool box, in a larger embodiment the store 13 can be a truck trailer or portacabin.

The store 13 is delivered to the worksite 12 from an off-site facility. In other embodiments, the store 13 can be configured as a room or tool store within a worksite 12.

The store 13 is stocked with a plurality of assets 11. As shown in FIG. 5, the store 13 includes a first asset in the form of a toolbox 11a and a second asset in the form of a hard-hat 11b. A third asset in the form of a drill 11c is located outside of the store 13. Each of the assets 11a to 11c is a unique asset. As such, each has a unique marker 15a to 15c associated therewith, respectively. Each of assets 11a to 11c has its own unique asset record 18a to 18c. Together, the corresponding asset records 18a to 18c of the respective assets 11a to 11c make up an asset registry 22.

The system 10 (which can be the automated asset tracking system 10a or the manned asset tracking system 10b) includes an interface device 30. The interface device 30 comprises a visual display 30a and an input device 30b. The interface device 30 is located at or near an entry 31 of the store 13. Whilst illustrated in FIG. 5 as being two separate components, it is also contemplated that the interface device 30 and the controller 17 can be integrated into a single device.

When collecting one or more of the assets 11 from the store 13, the user U selects the one or more assets 11 from the asset registry 22 using the interface device 30. Data from the corresponding asset record(s) 18 of the selected asset(s) 11 is presented on the visual display 30a to the user U. The data presented includes the storage location 29 of each of the selected asset(s) 11 within the store 13.

Whilst the supervisor S is illustrated in FIG. 5 as being inside the store 13, it is understood that the supervisor S is not required for every day operation of the store 13. Accordingly, the system 10 can be the automated asset tracking system 10a as discussed in earlier in relation to FIG. 2. In the automated asset tracking system 10a, the scanner 14 is the RFID scanner 14a, and the sensor is 16a (each shown in FIG. 2). The supervisor S can be located anywhere within the worksite 12, and only needs to visit the store 13 when specifically required to undertake tasks as further outlined. Alternatively, the system 10 shown in FIG. 5 can be the manned asset tracking system 10b, as discussed earlier in relation to FIG. 3. In the manned asset tracking system 10b, the scanner 14 is the mobile RFID scanner 14b and the sensor 16 is the supervisor S (each shown in FIG. 3).

It is also contemplated that the asset record 18 for non-consumable assets 24 includes safety data related to scheduled testing and/or maintenance of the respective non-consumable asset 24. The safety data is inputted into the controller 17 via the supervisor S. For example, the supervisor S can input required maintenance intervals and test and tag requirements for each asset 11 into the corresponding asset record 18.

The controller 17 monitors the safety data for each non-consumable asset 24, and alerts the supervisor S when maintenance and/or testing is due. In this way, the system 10 eliminates the need for the keeping of separate records related to testing and routine maintenance of equipment within the worksite 12. Furthermore, if safety data within the corresponding asset record 18 indicates that the respective non-consumable asset 24 is due for maintenance and/or testing, the respective non-consumable asset 24 will not be available for selection by the user U via the interface device 30. The supervisor S can also mark the asset 11 as requiring repair. Assets 11 that are marked for repair will also be blocked from selection by the user U and blocked from issuance from the store 13.

The mobile scanner 14b can also perform an auditing function. The auditing function is used by the supervisor S to identify and find assets 11 within the store 13 that have been flagged for repair or maintenance by the system 10. For example, the supervisor S can use the mobile scanner 14b to identify and find all assets 11 within the store 13 that are due for scheduled maintenance within a determined time period. The mobile scanner 14b uses proximity detection to find assets 11 requiring attention.

It is further envisaged that when using the interface device 30 to select asset(s) 11, the user U inputs job data related to the task(s) that are to be undertaken with the asset 11. The controller 17 writes the job data to the corresponding asset records(s) 18 when the asset(s) 11 are removed from the store 13. In this way, interrogation of the respective asset records 18 can show what specific tasks assets 11 are being used for.

A transceiver 33 is located within the worksite 12, outside the store 13. The transceiver 33 is in communication with the controller 17. The transceiver 33 is an RFID antenna that can detect the presence of RFID markers 15 within a sensing range of the transceiver 33. When the transceiver 33 detects a presence of the marker 15, the transceiver 33 reads the asset identification data form the marker 15 and relays the external asset location data and asset identification data to the controller 17 via a data packet. The controller 17 then writes the external asset location data to the asset record 18 corresponding to the asset 11 to which the marker 15 is associated. In this way, movement of the asset 11 around the worksite 12 can be monitored and tracked. It is understood that multiple transceivers 33 can be installed at different locations within the worksite 12. In this way, the transceiver(s) 33 can track where on the worksite 12 each asset 11 is used.

In the illustrated embodiment of FIG. 5, a single transceiver 33 is located at an exit 34 to the worksite 12. A worker W is attempting to leave the worksite 12 with drill 11c. The transceiver 33 detects the radio message from the marker 15c attached to the drill 11c. The transceiver relays asset position data related to the drill 11c to the controller 17. The controller 17 determines that the worker W is not authorised to remove the drill 11c from the worksite 12, and triggers alarm 35 at the exit 34. Accordingly, the transceiver 33 can be used for preventing unauthorised removal of an asset 11 from the worksite 12.

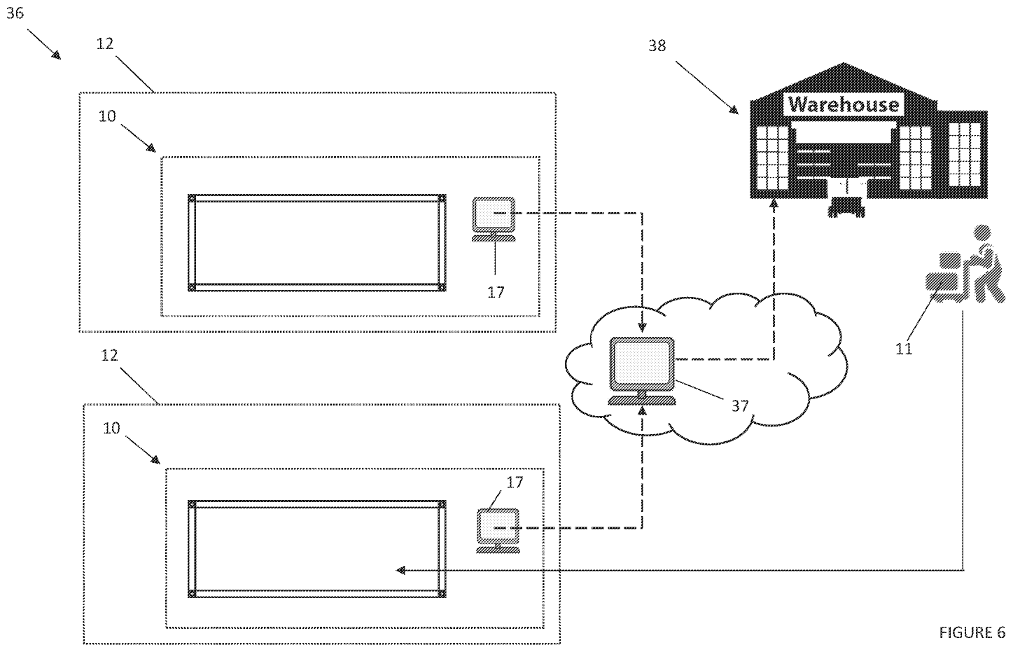

Optionally, the system 10 is part of an asset supply network 36. Such an embodiment is shown in FIG. 6, where two systems 10 are part of the asset supply network 36. The controller 17 of each system 10 is in communication with a central controller 37 via an external internet connection. The central controller 37 is located outside of each of the worksites 12. Periodically, the controller 17 of each system 10 sends asset location data from the asset records 18 to the central controller 37. As such, each of the asset records 18 from the controller 17 can be accessed via the central controller 37. In this way, the quantity of each asset 11 within each store 13 is remotely monitored by the central controller 37.

The central controller 37 is accessible to a supplier 38. The supplier 38 is a third-party distributor that replenishes the assets 11 within each of the stores 13. Accordingly, each of the stores 13 in the supply network 36 acts as a remote store-front for the supplier 38. By interrogating the central controller 37, the supplier 38 can see the asset levels at each of the worksites 12. The supplier may enter a threshold quantity of the asset or assets 11 into the central controller 37. Accordingly, the supplier 38 can ship additional assets 11 directly to the worksites 12 if the asset levels are below the threshold quantity, eliminating the need for a specific order or request from either of the worksites 12. This reduces down-time associated with the passage of time between a request for additional assets 11 from one of the worksites 12, and delivery of the assets 11 by the supplier 38.

It is also contemplated that the supplier 38 can supply assets 11 to the worksites 12 based on upcoming jobs required at the respective worksite 12. For example, the respective worksite 12 can issue a scope of upcoming works to the supplier 38, via the central controller 37. The scope of works can include a listing of jobs to be undertaken. Accumulated job data within the respective asset records 18 can be compared with the listing of upcoming jobs by the central controller 37, to predict which assets 11, and to calculate a expected quantity of assets 1 required for undertaking the upcoming jobs within the scope of works. The required assets 11, and expected quantity of assets 11, as calculated by the central controller 37, can then be compared to the actual quantity of assets 11 within the store 13. In this way, the central controller 37 is said to monitor the levels of asset within the store. Should any of the required assets 11 be absent from the store 13, or should the levels of asset 11 within the store be below the expected quantity of assets 11, then these predicted assets 11 can then be supplied by the supplier 38 to the respective asset store 13. As such, asset levels within the store can be maintained at the threshold level by the supplier 38, without the need for the supplier 38 to receive supply orders from the individual worksite 12.

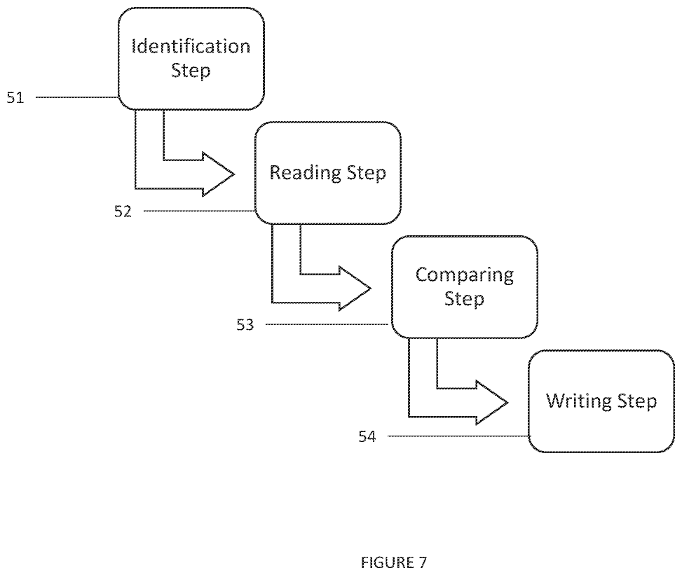

The method with which the asset tracking system 10 tracks the asset 11 within the worksite 12 will now be explained in reference to FIG. 7. It is noted that this method is applicable to both the automated tracking system as shown in FIG. 2, and the manned tracking system as shown in FIG. 3.

The method includes an identification step 51 which comprises identifying the user U moving the asset 11 into or out of the store 30 with the sensor 16. The sensor 16 then sends the user identification data to the controller 17 via the second data packet.

A reading step 52 comprises reading asset identification data from the marker 15 with the scanner 14. The scanner then transmits the asset identification data, along with asset location data, to the controller 17 in the first data packet. For non-consumable assets, the asset location data relates to one of the presence or absence of the asset within the storage zone 13. For consumable assets, the asset location data relates to the quantity of the consumable asset stored within the storage zone 13. In the embodiments discussed in reference to FIGS. 1-6 herein, the reading step 52 follows the identification step 51, being triggered by the controller 17 after the controller 17 receives identification data from the sensor 16. It is understood, however, that in other embodiments of the asset tracking system the reading step 52 can take place before or simultaneously with the identification step 51.

A comparing step 53 follows the reading step 52. During the comparing step 53, the controller 17 determines movement of the asset 11 into or out of the store 13 by comparing a first data packet received from the scanner 14 with the corresponding asset record 18 stored within the controller 17. If the asset location data within the first data packet differs from the asset location data stored in the asset record 18, a writing step 54 follows.

The writing step 54 comprises the controller 17 updating the asset record 18 by overwriting the previous asset location data stored within the asset record 18 with the first data packet, and writing the second data packet to the asset record 18, thereby associating the movement of the asset 11 with the identity of the user U.

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

LEGEND

| # No. | Name | # No. | |
|---|---|---|---|
| 10 | Asset tracking system | 30a | Visual display of |
| | | | interface device |
| 10a | Automated asset tracking system | 30b | Input device of |
| | | | interface device |
| 10b | Manned asset tracking system | 31 | Entry to store |
| 11 | Asset | 32 | Guidance system |
| 12 | Worksite | 33 | Transceiver |
| 13 | Store | 34 | Exit to worksite |
| 14 | Scanner | 35 | Alarm |
| 14a | RFID scanner | 36 | Asset supply network |
| 14b | Hand-held RFID scanner | 37 | Central controller |
| 15 | Identifier | 38 | Supplier |
| 16 | Sensor | 51 | Identification step |
| 16a | Camera | 52 | Reading step |
| 16b | Barcode reader | 53 | Calculating step |
| 17 | Controller | 54 | Writing step |
| 17b | Computer | | |
| 18 | Asset record | | |
| 19 | Location marker | | |
| 20 | Container marker | | |
| 22 | Asset registry | | |
| 23 | Consumable asset | | |
| 24 | Non-Consumable asset | | |
| 25 | Units of consumable asset | | |
| 26 | Containers | | |
| 27 | Interrogation device | | |
| 28 | Interior of store | | |
| 29 | Storage locations | | |
| 30 | Interface device | | |

1. A system for tracking an asset, comprising:
a store configured to house the asset;
a scanner configured to read asset identification data from a marker associated with the asset to identify the asset and thereby transmit asset location data and asset identification data to record the presence or absence of the asset within the store;
a sensor configured to read user identification data to identify a user when the user is within the store;
a controller configured to receive:
the asset identification data and the asset location data in a first data packet from the scanner; and
the user identification data in a second data packet from the sensor, and record the first data packet in conjunction with the second data packet in an asset record,
wherein the controller is configured to repeatedly receive and write the first and second data packets to the asset record to assess over a predetermined time period the presence of the asset within the store or the absence of the asset in conjunction with the user, to thereby track the asset.

2. The system of claim 1, wherein the asset is a non-consumable asset.

3. The system of claim 1, wherein the non-consumable asset is one of: a power-tool; a tool; a meter; a pair of gloves, a pair of goggles, a hard hat, a safety vest, a communication device, and a safety vest.

4. The system of claim 1, wherein the marker is attached to the directly non-consumable asset.

5. The system of claim 1, wherein the marker is attached to a location within or upon which the asset is stored inside the store.

6. The system of claim 5, further comprising a secondary scanner for reading the marker and assessing movement of the asset from and to the location.

7. The system of claim 1, wherein the asset is a consumable asset.

8. The system of claim 7, wherein the consumable asset is one of: a plurality of fasteners, a plurality of nails, a plurality of screws, a quantity of fuel and a quantity of lubricant.

9. The system of claim 7 wherein the marker is attached to a container in which the consumable asset is stored.

10. The system of claim 9, wherein the container comprises an interrogation device configured to determine the quantity of the consumable asset therein.

11. The system of claim 10, wherein the interrogation device is a weigh scale.

12. The system of claim 10, further comprising a movement detector for detecting movement of the asset from and to the container.

13. The system of claim 8 wherein the asset location data comprises the quantity of the consumable asset stored within the container.

14. The system of claim 8 wherein the asset identification data comprises the quantity of the consumable asset stored within an individual unit.

15. The system of claim 8 wherein the individual unit is a packet comprising a discrete quantity of the consumable asset

16. The system of claim 1, wherein the marker is a transmitter.

17. The system of claim 16, wherein the marker is a RFID tag.

18. The system of claim 1, wherein the marker is a barcode.

19. The system of claim 1, further comprising a transceiver to detect a location of the asset outside of the store.

20. The system of claim 19, wherein the transceiver is configured to send external asset location data to the controller.

21. The system of claim 1, wherein the asset record is linked to safety data for the asset, to record on the asset record at least one of: scheduled testing dates; maintenance information; and working life information.

22. The system of claim 1, wherein the asset is one of a plurality of assets stored in the store, each of the plurality of assets having a marker.

23. The system of claim 1, wherein the marker is unique to the asset.

24. The system of claim 23, wherein each asset record is associated with the unique marker.

25. The system of claim 24, further comprising an asset registry, the asset registry comprising each of the asset records.

26. The system of claim 25, further comprising a user interface from which the user selects the asset from the asset registry.

27. The system of any claim 26, wherein the store comprises a guide configured to direct the user to the asset within the store.

28. The system of any one of the preceding claims, wherein the sensor is a camera.

29. The system of claim 1, wherein the sensor is a barcode reader.

30. The system of claim 1, wherein the sensor is a person.

31. The system of claim 1, wherein the store is transportable.

32. The system of claim 1, wherein the store is a shipping container.

33. A network comprising a central controller and an asset tracking system;
the asset tracking system located within a worksite and comprising a store configured to house the asset and a controller within which an asset record associated with the asset is stored, the asset record comprising asset identification data and asset location data related to the asset; the central controller being located outside of the worksite; wherein the central controller reads asset location data from the asset record within the controller of the asset tracking system, to remotely assess one of whether the asset is present or absent within the store or the quantity of the asset present within store.

34. The network of claim 33, wherein the asset tracking system is one of a plurality of asset tracking systems within the network, wherein the central controller read asset location data from each of the controllers of each of the asset tracking systems.

35. A method for tracking an asset, the method comprising the following steps:
(a) reading asset identification data from a marker associated with the asset with a scanner to identify a presence or absence of the asset within a store, and transmitting asset identification data and asset location data to a controller in a first data packet;
(b) reading user identification data with a sensor to identify a user moving into or out of the store, and transmitting the user identification data in a second data packet to the controller;
(c) comparing the first data packet received from the scanner with a corresponding asset record stored within the controller to assess a change in the presence or absence of the asset within the store; and
writing the first data packet and second data packet to the asset record with the controller if the asset location data within the first data packet differs from asset location data previously stored in the asset record, to thereby track the asset.

36. The method of claim 35, wherein at least one of steps (a) and (b) are undertaken by a person.

37. The method of claim 35, wherein step (a) comprises reading asset identification data from an RFID tag associated with the asset.

38. The method of claim 35, wherein step (a) comprises reading asset identification data from a barcode associated with the asset.

39. The method of claim 35, wherein step (a) comprises reading asset identification data from the marker, the marker being attached to a location within the or upon which the asset is stored inside the store.

40. The method of claim 35, wherein step (b) comprises identifying the user with a camera.

41. The method of claim 35, wherein step (a) occurs after step (b), with the scanner performing a scan of the store after receiving the second data packet.

42. The method of claim 35, wherein step (a) is a reoccurring step that is triggered over predetermined time intervals.

43. The method of claim 35, used to track a plurality of assets stored within the store.
